(19) United States
(12) Patent Application Publication
(10) Pub. No.: US 2011/0051277 A1
(43) Pub. Date: Mar. 3, 2011

(54) METHOD FOR ERASING MAGNETIC TAPES

(76) Inventor: Richard L. Bradshaw, Tuscon, AZ (US)

(21) Appl. No.: 12/870,336

(22) Filed: Aug. 27, 2010

Related U.S. Application Data
(60) Provisional application No. 61/237,351, filed on Aug. 27, 2009.

(51) Int. Cl. G11B 5/02

(52) U.S. Cl. 360/57; G9B/5.026

(57) ABSTRACT

A method is provided for securely erasing residual data on a magnetic tape formatted with a plurality of servo patterns providing boundaries between a plurality of data bands containing data that is recorded thereon during normal write operations, the data being written on many adjacent data tracks that run parallel to an edge of the magnetic tape. The method includes identifying a first edge of each of the plurality of servo patterns and erasing a portion (for example, a first half) of each of the plurality of data bands during a first pass of a tape head as it moves in a first direction. The method further includes the step of indexing the tape head to identify an opposite second edge of each of the plurality of servo patterns and erasing a different portion (for example, an opposite second half) of each of the plurality of data bands during a second pass of the tape head as the tape head moves in a second direction opposite the first direction.

### CROSS REFERENCE TO RELATED APPLICATION

This application claims the benefit of U.S. Provisional Patent Application Ser. No. 61/237,351, entitled “Method for Erasing Magnetic Tapes”, filed Aug. 27, 2009.

### BACKGROUND OF THE INVENTION

1. Field of the Invention

The invention relates to a method for erasing magnetic tapes.

2. Description of the Related Art

Current secure erasure of data on magnetic media requires demagnetization, degaussing or overwriting of the written information on a tape. All methods and operations that do not use a data write/read capable tape transport destroy the ability to reuse the media as the factory written format is lost in these operations. The currently available methods for data erasure, while capable of rendering the tapes re-useable without readily detecting residual data, do not remove enough of the residual data on the tapes to make the tapes “secure” from the perspective of many of the legal requirements currently attempting to control the escape of private information.

The attributes of the tape technology of interest to the application of this method are described in a number of publications. Concise reviews of state of the art technology for tape formats and recording heads are described in G. A. Jaquette, “LTO: A Better Format for Mid-Range Tape”, IBM Journal of Research & Development, Vol. 47, No. 4, pp. 429-444, 2003; E. R. Childers, et al., “Six Order of Magnitude in Linear Tape Technology: The One-Terabyte Project”, IBM Journal of Research & Development, Vol. 47, No. 4, pp. 471-482, 2003; and R. G. Biskeborn and J. H. Eaton, “Hard Disk Drive Technology Flat Heads for Linear Tape Recording”, IBM Journal of Research & Development, Vol. 47, No. 4, pp. 385-400, 2003, all of which are incorporated herein by reference.

With the current deficiencies in the technology relating to the erasure of tapes, a need exists for a method and system which can securely overwrite the residual data on a tape to a precision currently not practiced on operational tape transports.

### SUMMARY OF THE INVENTION

It is, therefore, an object of the present invention to provide a method for securely erasing residual data on a magnetic tape formatted with a plurality of servo patterns providing boundaries between a plurality of data bands containing data that is recorded thereon during normal write operations, the data being written on many adjacent data tracks that run parallel to an edge of the magnetic tape. The method includes identifying a first edge of each of the plurality of servo patterns and erasing a portion of each of the plurality of data bands during a first pass of a tape head as it moves in a first direction. The method further includes the step of indexing the tape head to identify an opposite second edge of each of the plurality of servo patterns and erasing a different portion of each of the plurality of data bands during a second pass of the tape head as the tape head moves in a second direction opposite the first direction.

It is another object of the present invention to provide a method wherein the tape head includes a servo read element capable of following the servo patterns.

It is a further object of the present invention to provide a method wherein the plurality of servo patterns are servo bands.

It also an object of the present invention to provide a method wherein the plurality of data bands includes four data bands that are simultaneously erased by the tape head.

It is another object of the present invention to provide a method wherein the tape head includes a plurality of erase elements spread along a length of the tape head.

It is a further object of the present invention to provide a method wherein each of the erase elements is shaped and dimensioned to at least overwrite half of a data band.

It is also an object of the present invention to provide a method wherein the tape head includes a plurality of servo read elements, and the method includes the step of monitor tape erasure as the tape is being erased.

It is another object of the present invention to provide a method wherein the step of identifying the first edge of each of the plurality of servo patterns and erasing a portion of each of the plurality of data bands during a first pass of the tape head as it moves in the first direction includes erasing a first half of each of the plurality of data bands.

It is a further object of the present invention to provide a method wherein identifying the opposite second edge of each of the plurality of servo patterns and erasing a different portion of each of the plurality of data bands during the second pass of a tape head as the tape head moves in a second direction opposite the first direction includes erasing an opposite second half of each of the plurality of data bands.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWINGS

FIGS. 1, 2 and 3 are schematics showing LTO format on a magnetic tape.

FIG. 4 is a schematic showing erasure of a magnetic tape in accordance with the present invention.

FIGS. 5, 6A and 6B are schematics showing a tape head and operation thereof in accordance with the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

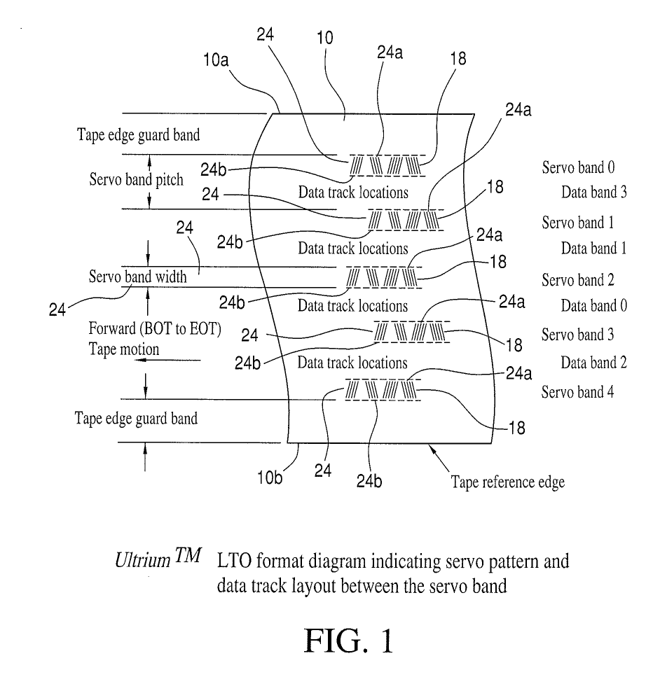

In accordance with the present invention, and with reference to FIGS. 1, 2, 3, 4, 5, 6A and 6B, a method for securely erasing (or overwriting) residual data on a magnetic tape 10 to a precision currently not practiced on operational tape transports is provided. In general, the present invention provides a mechanism by which the factory written servo format is followed as the magnetic tape is spooled out of a cartridge. A broad width erase head is run down the magnetic tape holding the erase element of the tape head within 1-2 microns of the edge of the formatted servo band. Upon reaching the end of the magnetic tape, the tape head is either moved down to follow the next servo band or a separate set of erase elements in the fixed structure of the tape head (two potential ways to do this) are turned on so as to overlap the previously overwritten band of data tracks and complete erasure of data tracks within 1-2 microns of the upper edge of the servo format band.

Briefly, the present invention provides a method for securely erasing residual data on a magnetic tape 10 formatted with a plurality of servo patterns 18 providing boundaries between a plurality of data bands 28a-d containing data that is recorded thereon during normal write operations, the data being written on many adjacent data tracks 20 that run parallel to an edge 10a, 10b of the magnetic tape 10. The method includes identifying a first edge 24a of each of the plurality of servo patterns 18 and erasing a portion (for example, a first half) of each of the plurality of data bands 28a-d during a first pass of a tape head 12 as it moves in a first direction. The method further includes the step of indexing the tape head 12 to identify an opposite second edge 24b of each of the plurality of servo patterns 18 and erasing a different portion (for example, an opposite second half) of each of the plurality of data bands 28a-d during a second pass of the tape head 12 as the tape head 12 moves in a second direction opposite the first direction.

In accordance with the present invention, currently available commercial tape drives are modified for the purpose of data eradication, not data reading or interchange. Custom built magnetic tape heads 12 are used to precisely track the existing servo format on the magnetic tape 10, but rather than contain complex data write/read elements, the magnetic tape heads 12 employed in accordance with the present invention contain multiple wide erase elements 14 capable of creating a higher AC erase field than typical data erasure heads used in the normal operational data processing heads in the drives.

Since closely packed erase elements are not required for the broad area overwrite employed in accordance with the present invention, as compared to applications requiring writing discrete narrow tracks in close proximity during data writing, more turns can be used in the electromagnet of the tape head used in accordance with the present invention. The greater the number of turns on the coil of the erase element, the higher the magnetic field. In addition, since rapid creation of reversed magnetic fields (ones and zeros) in data writing is not needed for implementation of the present invention, the magnetic field created by the erase element can be sustained at peak levels during erasure. This is well known to those skilled in the art for dedicated “erase” heads and is covered in several patents on erase head design, such as, U.S. Pat. No. 6,894,869, to Dugas, Advanced Research Corporation, May 17, 2005, entitled “Low inductance, ferrite sub-gap substrate structure for surface film magnetic recording heads”, U.S. Pat. No. 7,009,810, to Dugas, Mar. 7, 2006, entitled “Thin-film magnetic recording head having a timing-based gap pattern for writing a servo track on magnetic media”, U.S. Pat. No. 7,256,962, to Tateishi, Aug. 14, 2007, “Magnetic tape drive with AC erase element upstream from plural head elements”, U.S. Pat. No. 7,492,550, to Samofalov et al., Feb. 17, 2009, entitled “Magnetic recording head and method for high coercivity media, employing concentrated stray magnetic fields”, all of which are incorporated herein by reference.

Servo read elements 32a, 32b are only provided on the leading and trailing edges of the wide erase structures, that is, the erase elements 14, so as to verify the overwrite and track position relative to the servo position error signal. The existing servo detection capabilities of the tape drives and embedded, standard operational protocols are used to exercise the magnetic tape and perform the track following operation. It should be appreciated that since no data is written or read in accordance with the present invention, none of the proprietary embedded functions of the tape drives would be used and implementation of the present invention should not violate the intellectual property rights of others.

In accordance with a preferred implementation of the present invention, a blank commercial magnetic tape 10 is factory formatted with servo patterns 18 on the tape which provide boundaries between which data that is recorded thereon during normal write operations. For the purposes of explaining the present invention, the Ultrium™ LTO format is used as a representative example in FIG. 1. However, and as those skilled in the art will certainly appreciate, other formatting protocols may be employed without departing from the spirit of the present invention.

Published standards describe the servo formats and interchange attributes for the various tapes of interest as subjects for the application of the present method for data erasure and tape reuse. For example, the servo formats and interchange attributes described in the following publications could be employed in the implementation of the present invention: ECMA Standard 196, “Data Interchange on 12.7 mm 36-Track Magnetic Tape Cartridges”, December 1993; ECMA Standard 278, “Data Interchange on 12.7 mm 128-Track Magnetic Tape Cartridge—Parallel Serpentine Format”, 2^{nd} Edition, June 2000; and ECMA Standard 319, “12.7 mm 383-Track Magnetic Tape Cartridges—Ultrium-1 Format”, June 2001, all of which are incorporated by reference.

As those skilled in the art will certainly appreciate, when data is written to magnetic tape 10 using linear tape recording, the data is written on many adjacent data tracks 20 that run parallel to the edge of the magnetic tape 10. In fact, using digital tape technology it is possible to write many data tracks 20 across a single magnetic tape 10. This allows users to store large amounts of data along a limited quantity of magnetic tape 10. Since many data tracks 20 are written across a single strand of the magnetic tape 10, it is necessary to provide a track-following servo, that is, a mechanism that allows a tape head 12 to dynamically follow a tape data track 20. A tape drive 22 using a track-following servo will constantly move the tape head 12, the component that actually performs the read, write and erase functions, and align it to the desired data track 20.

When implementing the LTO format in magnetic tape, electronic signals are generated through the real-time reading of servo data bands (or servo tracks) 24 that are prerecorded on the LTO tape. Servo tracks 24 enable accurate positioning of the tape heads 12 of the tape drive 22 over the data track 20, ensuring that the tape head 12 does not stray onto an adjacent data track 20. They are necessary to support high-data densities on the magnetic tape 10 where the data tracks 20 are extremely close together. The servo bands 24 are written when the cartridge in which the magnetic tape 10 is mounted is manufactured, before the cartridge is usable for data storage and retrieval. If the servo bands 24 are erased, the magnetic tape 10 becomes unusable.

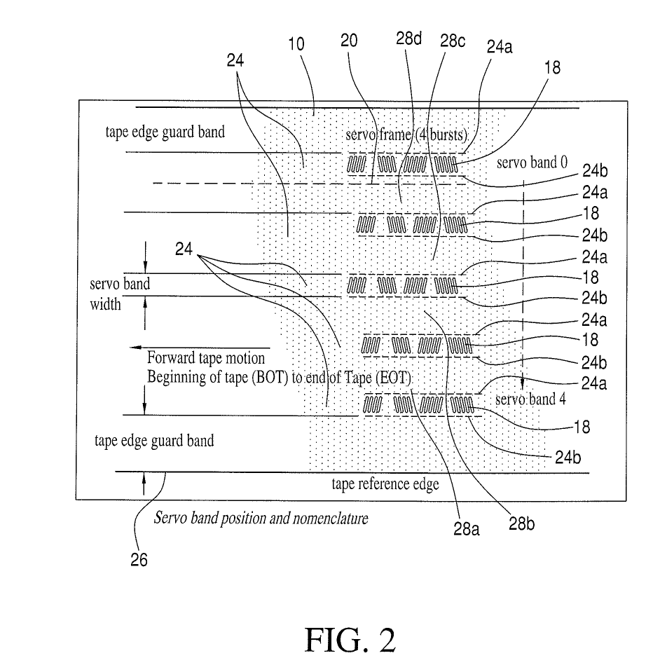

With reference to the example of an LTO formatted magnetic tape 10, as shown in FIG. 2, five servo bands 24, numbered 0 through 4, make up the servo tracking mechanism on the LTO Ultrium magnetic tape 10. They are each located at specific distances from the tape references edge 26.

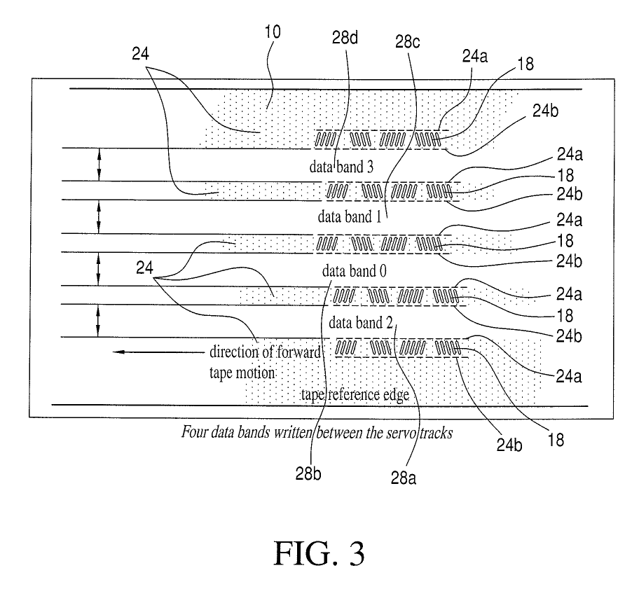

Referring to FIG. 3, the area between adjacent servo bands 24 is a data band 28a-d. There are four data bands 28a, 28b, 28c, 28d, where data band 28a is nearest to the tape references edge 26 of the magnetic tape 10 and data band 28d is farthest away. Each data band 28a-d includes a number of data tracks 20 that are simultaneously recorded from one end of the magnetic tape 10 to the other end in a manner well known to those skilled in the art.

The recording format employed in conjunction with Ultrium LTO format has a serpentine characteristic. The mechanism employed in the tape drive 22 allows the tape head 12 to make multiple passes from the beginning of the magnetic tape 10 to the end of the magnetic tape 10 and back to read, write or erase the full capacity of the magnetic tape 10 maintained within the data cartridge. For example, different levels of data density are possible when employing the Ultrium LTO format; the Ultrium 1 format allows for 384 data tracks to be split into four data bands of 96 data tracks each, the Ultrium 2 format allows for 512 data tracks to be split into four data bands of 128 data tracks each, the Ultrium 3 format allows 896 data tracks to be split into four data bands of 224 data tracks each.

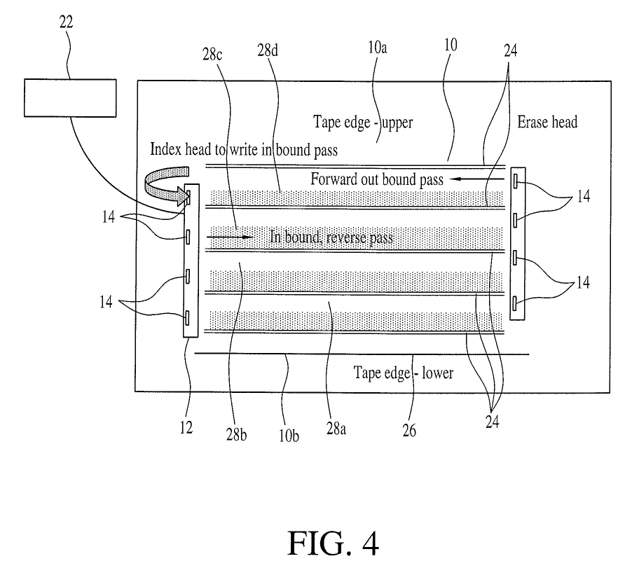

When implementing the present method, all four data bands 28a-d are simultaneously erased by tape head 12 constructed in accordance with the present invention and shown below with reference to FIG. 4. More particularly, and in accordance with a preferred embodiment of the present invention, the tape drive 22 includes a tape head 12 having four erase elements 14 spread along the length of the tape head 12. The erase elements 14 are shaped and dimensioned on the tape head 12 to overwrite at least half of the data band 28a-d region of the tape format that exists between each servo band 24. It should be appreciated the erase elements are sized to create a slight erasure overlap as the erase elements 14 erase the data bands 28a-d during the inbound pass and outbound pass as discussed herein so that the erasure of each data band 28a-d is complete. However, it should be understood the erase element 14 may not overlap the servo band 24 so as to protect the servo band 24 from inadvertent erasure.

In the implementation of the present invention in the LTO example discussed above, four erase elements 14 are built into the tape head 12 to simultaneously erase or overwrite one half of each of the four data bands 28a-d (for example, 48 data tracks on each data band of an Ultrium 1 format magnetic tape, 64 data tracks of each data band of an Ultrium 2 format magnetic tape, and 112 data tracks of each data band of an Ultrium 3 format magnetic tape). As a result, one half of all four data bands 28a-d are erased on each pass of the tape head 12 as depicted in the diagram in FIG. 4.

As such, and in accordance with a preferred embodiment of the present invention, when the cartridge in which the magnetic tape is supported is inserted into the drive mechanism 22, a threading mechanism of the drive mechanism 22 pulls the leader pin and attached tape out of the cartridge, across the tape head, and onto a non-removable take-up (machine) reel. The tape head 12 can then erase data from or to the magnetic tape 10. The present invention is directed to the erasure of standard magnetic tapes, and consequently the basic structure of the drive mechanism and the cartridge will be the same as currently employed and well known to those skilled in the art. For example, such structures are disclosed in U.S. Pat. Nos. 7,453,361, to Findlay, Nov. 18, 2008, entitled “Refurbishing and resale techniques for data storage tape”, 7,304,576, to Findlay, Dec. 4, 2007, entitled “Refurbishing and resale techniques for data storage tape”, 7,256,962, to Tateishi, Aug. 14, 2007, entitled “Magnetic tape drive with AC erase element upstream from plural head elements”, 6,707,630, to Doi et al., Mar. 16, 2004, entitled “Method for managing life of a storage medium, storage device, storage system, and storage medium”, 6,385,557, to Mundo, May 7, 2002, entitled “Tracking the remaining useful like of a magnetic data storage tape”, 5,426,543, to Dy et al., Jun. 20, 1995, entitled “Servo positioning system for magnetic recording media”, 5,229,895, to Schwarz et al., Jul. 20, 1993, entitled “Multi-track servo recording head assembly”, and 4,631,479, to Haga, Dec. 23, 1986, entitled “Error locator for high-speed inspection of magnetic tape”, the relevant disclosures of which are incorporated herein by reference.

At this point the magnetic tape 10 is moved in a first, or forward, direction relative to the tape head 12 and the respective four erase elements 14 of the tape head 12 erase (or overwrite) half the data tracks 20 (that is one half of the data band 28a-d) between the servo bands 24 on one edge of all the servo bands 24 on the outbound pass. Upon reaching the logical end of the magnetic tape 10 (which is encoded into the operational software using format length statements already written on the magnetic tapes 10 by the tape producer and stated in standards for these formats and as such are in the public domain) the tape head 12 is indexed so as to position the respective four erase elements 14 over the remaining data tracks 20 (that is, the other half) adjacent the opposite servo band 24, that is, the opposite side of the data band 28a-d. As a result, the entire magnetic tape 10 is erased or overwritten in one full file pass of the magnetic tape 10. This allows an acceptable time (less than 5-6 minutes) to perform the entire data erasure operation.

Since data is not read or written in the operation of the tape drive 22 employed in accordance with the present invention, but the data bands 28a-d are only monitored to confirm no residual patterns of the original data, the magnetic tape 10 would run at the maximum speed at which the drive 22 can reliably run while following the servo format which is typically significantly faster than normal drive operation during data write or read operations.

As is well known to those skilled in the art, track following servo readers 30 would be placed in the tape head 12 to achieve optimum position error detection and response to the head actuator to maintain optimum on track guiding during the operation at the highest possible tape speed.

The present invention provides for the enablement of one device to process multiple tape formats. In particular, since the application of the present invention is for generic tape processing, the restrictions imposed by various restrictive tape formats for write compliance are not applicable and the devices used for this process do not need to recognize these restrictions. As a result, one format overwrite processing capable device can erase data on all formats with a compatible servo pattern.

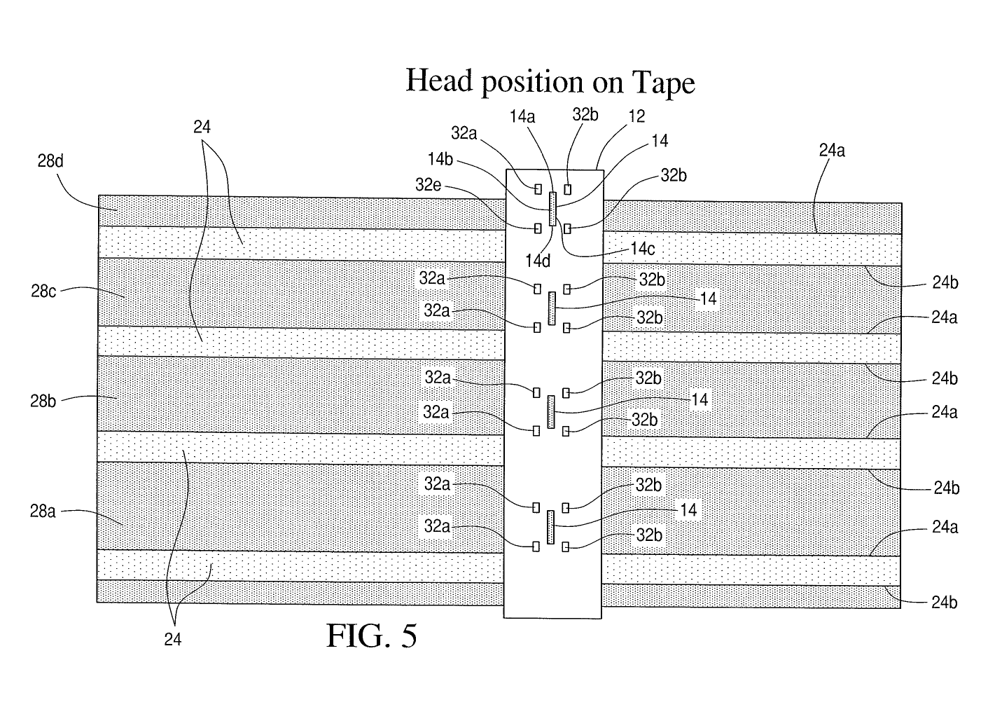

The erasure of the data is also verified as the tape head 12 is moved across the magnetic tape 10. In particular, the tape head 12 is provided with servo read elements 32a, 32b for monitoring the magnetic tape 10 to ensure that all data is erased in accordance with the present invention. More particularly, and as briefly discussed above, servo read elements 32a, 32b are built into the tape head 12 so that they may monitor the erasure magnetic tape 10 as the magnetic tape 10 is moved across the tape head 12 in accordance with the present invention. Referring to FIG. 5, the positioning of the servo read elements 32a, 32b and erase elements 14 is repeated across the span of the tape head 12 as needed to follow the top and bottom edges 24a, 24b of the servo band 18 during the outbound motion of the magnetic tape 10. In accordance with a preferred embodiment, a pair of servo read elements 32a, 32b is located adjacent a top side 14a of each erase element 14 with the respective servo read elements 32a, 32b located on the left side 14b and right side 14c of the erase element 14 and a pair of servo read elements 32a, 32b is located adjacent a bottom side 14d of each erase element 14 with the respective servo read elements 32a, 32b located on the left side 14b and right side 14c of the erase element 14. It should be appreciated the terms left, right, top and bottom are relative terms dependent upon the perspective from which one views the various elements and this description is provided with reference to FIG. 5. Ultimately, the erase element 14 is “sandwiched” between the servo read elements 32a, 32b so the same tape head 12 can be used for both erasure and verification as discussed below in greater detail. On the return motion of the magnetic tape 10 back into the cartridge, a duplicate pair of servo read elements 32a, 32b not active during the outbound motion is electrically switched so as to perform the same operation in the reverse direction.

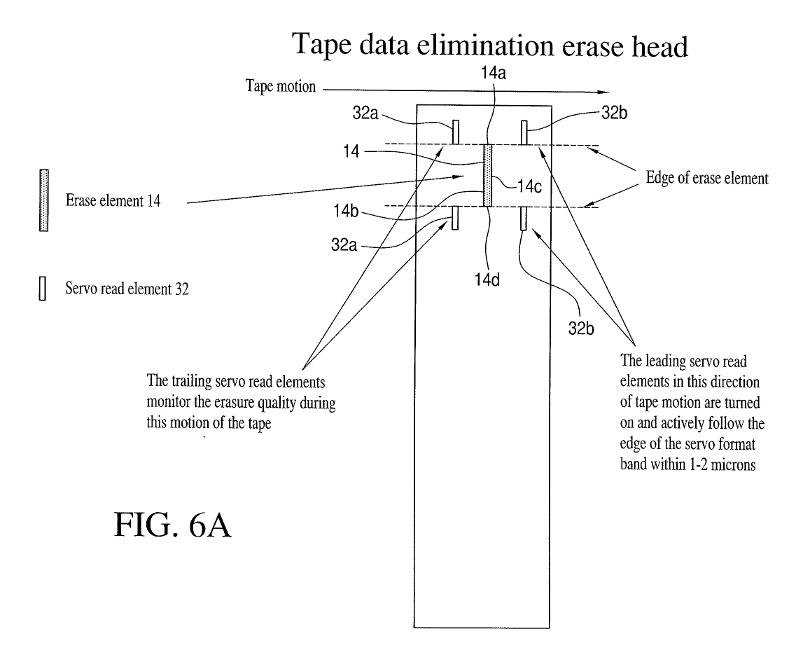

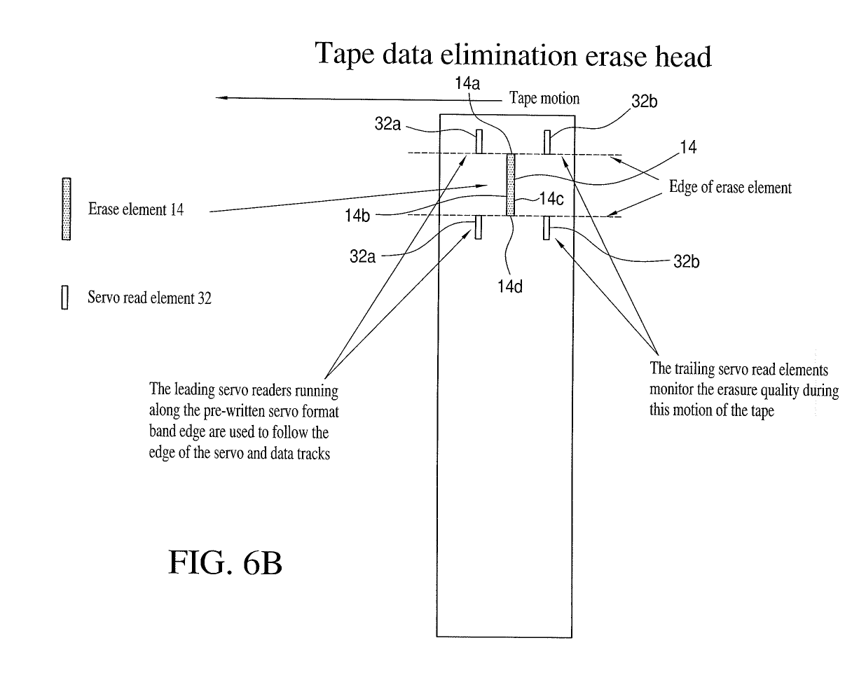

In particular, and with reference to FIGS. 6A and 6B, servo read elements 32a (trailing) monitor the erasure quality and servo read elements 32b (leading) actively follow either the top or bottom edge 24a, 24b of the servo band 24 when the tape moves in the first direction shown in FIG. 6A and servo read elements 32b (trailing) monitor the erasure quality and servo read elements 32a (leading) actively follow the top or bottom edge 24a, 24b of the servo band 24 when the tape moves in the opposite second direction shown in FIG. 6B. As shown in accordance with a preferred embodiment as shown with reference to FIG. 4, the read elements 32a, 32b positioned adjacent the top of the erase elements 14 follow the bottom edges 24b of the servo bands 24 on the outbound pass (with the read element 32a trailing and read element 32b leading) and the read elements 32a, 32b positioned adjacent the bottom of the erase elements 14 follow the top edges 24a of the servo bands 24 on the outbound pass (with the read element 32b trailing and read element 32a leading) after the tape head 12 has been indexed.

It should be appreciated the ability of the trailing read element 32a, 32b to read, and thereby monitor, the data tracks for monitoring erasure quality after erasure while the erase is going on is important to provide concurrent verification of erasure.

As those skilled in the art will certainly appreciate, the drive mechanism employed in accordance with the present invention may be constructed in a variety of manners depending upon the specific requirements (for example, depending upon performance and specification requirements, such as, the desired erasure rate or quality design points) of different manufacturers without departing from the spirit of the present invention.

While the preferred embodiments have been shown and described, it will be understood that there is no intent to limit the invention by such disclosure, but rather, is intended to cover all modifications and alternate constructions falling within the spirit and scope of the invention.

1. A method for securely erasing residual data on a magnetic tape formatted with a plurality of servo patterns providing boundaries between a plurality of data bands containing data that is recorded thereon during normal write operations, the data being written on many adjacent data tracks that run parallel to an edge of the magnetic tape, comprising:
identifying a first edge of each of the plurality of servo patterns and erasing a portion of each of the plurality of data bands during a first pass of a tape head as it moves in a first direction;
indexing the tape head to identify an opposite second edge of each of the plurality of servo patterns and erasing a different portion of each of the plurality of data bands during a second pass of the tape head as the tape head moves in a second direction opposite the first direction.

2. The method according to claim 1, wherein the tape head includes a servo read element capable of following the servo patterns.

3. The method according to claim 1, wherein the plurality of servo patterns are servo bands.

4. The method according to claim 1, wherein the plurality of data bands includes four data bands that are simultaneously erased by the tape head.

5. The method according to claim 1, wherein the tape head includes a plurality of erase elements spread along a length of the tape head.

6. The method according to claim 5, wherein each of the erase elements is shaped and dimensioned to overwrite at least half of a data band.

7. The method according to claim 1, wherein the tape head includes a plurality of servo read elements, and the method includes the step of monitor tape erasure as the tape is being erased.

8. The method according to claim 1, wherein the step of identifying the first edge of each of the plurality of servo patterns and erasing a portion of each of the plurality of data bands during the first pass of a tape head as it moves in a first direction includes erasing a first half of each of the plurality of data bands.

9. The method according to claim 8, wherein identifying the opposite second edge of each of the plurality of servo patterns and erasing a different portion of each of the plurality of data bands during the second pass of the tape head as the tape head moves in the second direction opposite the first direction includes erasing an opposite second half of each of the plurality of data bands.
